(19) United States
(12) Patent Application Publication
(10) Pub. No.: US 2010/0011821 A1
(43) Pub. Date: Jan. 21, 2010

(54) SYSTEM FOR CONTROLLING DOOR LOCKING DEVICES FOR VEHICLE

(75) Inventor: Ho Hyung KIM, Incheon-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/464,735

(22) Filed: May 12, 2009

(30) Foreign Application Priority Data
Jul. 15, 2008 (KR) 10-2008-0068506

(51) Int. Cl. E05B 65/36

(52) U.S. Cl. 70/264

(57) ABSTRACT

A system for controlling door locking devices may include inside door handles each configured to include a grip for unlocking the door locking devices, mounted in a vehicle and opening a door, and a display unit for displaying whether the door locking device is locked or unlocked, and at least an external switch module mounted outside the inside door handles, each electrically-connected to the door locking devices, and each configured to enable a vehicle occupant to control the door locking devices.

### CROSS-REFERENCE TO RELATED APPLICATION

The present application claims priority to Korean Patent Application Number 10-2008-0068506 filed Jul. 15, 2008, the entire contents of which application is incorporated herein for all purposes by this reference.

### BACKGROUND OF THE INVENTION

1. Field of the Invention

The present invention relates generally to a system for controlling door locking devices, and, more particularly, to a system for controlling door locking devices, which can lock and unlock door locking devices without using existing safety knobs, and can directly display the locked or unlocked states of doors.

2. Description of Related Art

The door locking devices for a vehicle are locked manually through manipulation by a vehicle occupant or locked automatically after the vehicle occupant gets in the vehicle, and doors are not opened even when the vehicle occupant intentionally or unintentionally manipulates the inside door handles.

FIG. 1 is a view showing the locked and unlocked states of a door locking device disposed in an inside door handle which is configured to include a safety knob.

The inside door handle 1, shown in FIG. 1, includes a safety knob 10, a door's locked/unlocked state mark 11, and a grip 12. A vehicle occupant manipulates the safety knob 10 so that a door locking device can be switched between the locked and unlocked states, thereby controlling the door locking device.

Further, the door's locked/unlocked state mark 11 is provided on one side of the safety knob 10. Therefore, in a locked state 2, the locked/unlocked state mark 11 faces the inside of the inside door handle, so that the locked/unlocked state mark 11 is not visible by the vehicle occupant, and, in an unlocked state 3, the locked/unlocked state mark 11 faces the outside of the inside door handle, so that the locked/unlocked state mark 11 is visible to the vehicle occupant, thereby informing the vehicle occupant whether the door is locked or unlocked.

When the safety knob 10 is manipulated, the safety knob 10 operates in conjunction with a latch motor or a latch gear, so that the door locking device can switch between the locked and unlocked states. When the door locking device is in the locked state, the vehicle occupant manipulates the safety knob 10 and unlocks the door locking device first, and then pulls the inside door handle of a door, so that the vehicle occupant can open the door.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a system for controlling door locking devices, which uses one or more external switches each for providing a function of locking and unlocking a door, that is, the function of an existing safety knob, and uses inside door handles for directly displaying the locked and unlocked states of a door for a vehicle occupant.

In an aspect of the present invention, a system for controlling door locking devices may include inside door handles each configured to include a grip for unlocking the door locking devices, mounted in a vehicle and opening a door, and a display unit for displaying whether the door locking device is locked or unlocked, and at least an external switch module mounted outside the inside door handles, each electrically-connected to the door locking devices, and each configured to enable a vehicle occupant to control the door locking devices.

The grip may be disposed in at least one of inside door handles mounted in respective front door of the vehicle and in case that the grip is pulled once, a corresponding door locking device is unlocked and a corresponding door is opened.

The grip may be disposed in at least one of inside door handles and in case that the grip is pulled twice, a corresponding door locking device is unlocked through first pulling of the grip and a corresponding door is opened through second pulling of the grip.

The grip may be included in one of inside door handles in the rear doors.

The display unit may display whether the corresponding door locking device is locked or unlocked, based on operation of a position switch which operates in response to a signal transmitted through at least one of the inside door handles and the external switch modules.

The display unit may be a Light Emitted Diode (LED) display unit.

Each of the external switch modules may be realized using a touch screen of a display mounted inside the vehicle.

The external switch module may enable the vehicle occupant to lock or unlock the locking devices for the respective doors through the touch screen.

The external switch modules may be mounted near or onto a center fascia.

The external switch modules may be mounted near or onto a center console of the vehicle.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view showing the locked and unlocked states of a door locking device disposed in an inside door handle which is configured to include a safety knob in a conventional art.

FIG. 2 is a view showing an exemplary system for controlling door locking devices which uses external switches according to the present invention.

FIGS. 3A and 3B are views showing an exemplary inside door handle including a Light Emitting Diode (LED) display unit for displaying whether a door locking device is locked or unlocked according to the present invention.

FIG. 4 is a circuit diagram showing an exemplary LED display unit according to the present invention.

FIG. 5 is a flowchart showing an example of a process of locking a door according to the present invention.

FIG. 6 is a flowchart showing an example of a process of unlocking a door according to the present invention.

FIGS. 7A to 7C are views showing an exemplary operation of the LED display unit together with the configurations thereof during the process of locking/unlocking a door according to the present invention.

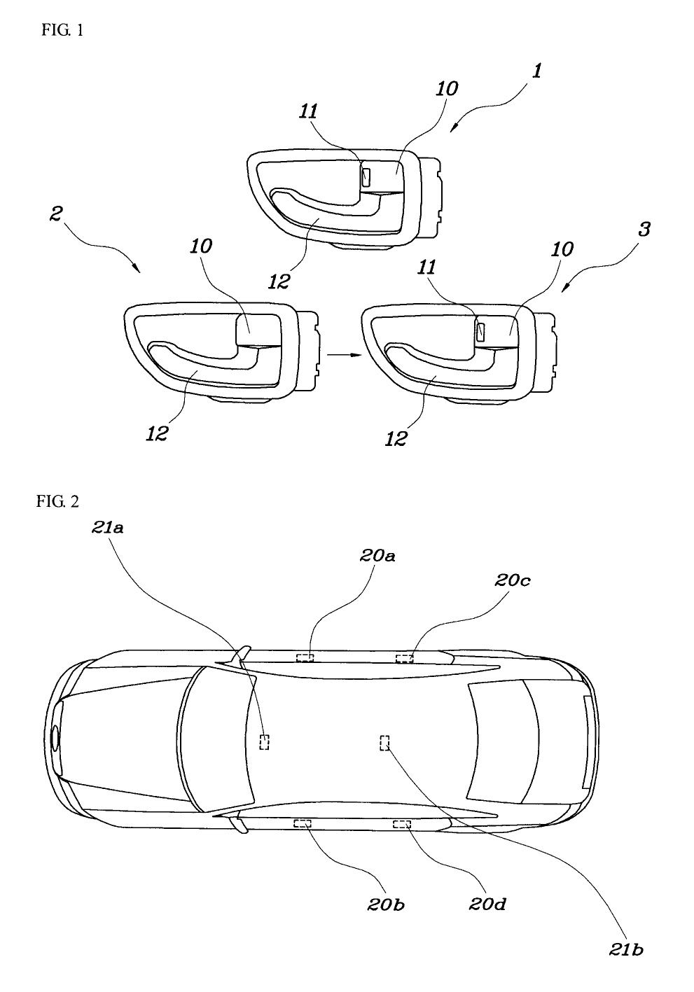

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

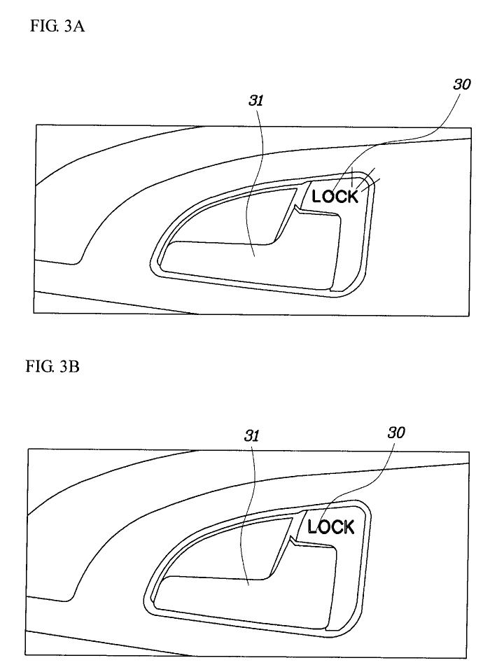

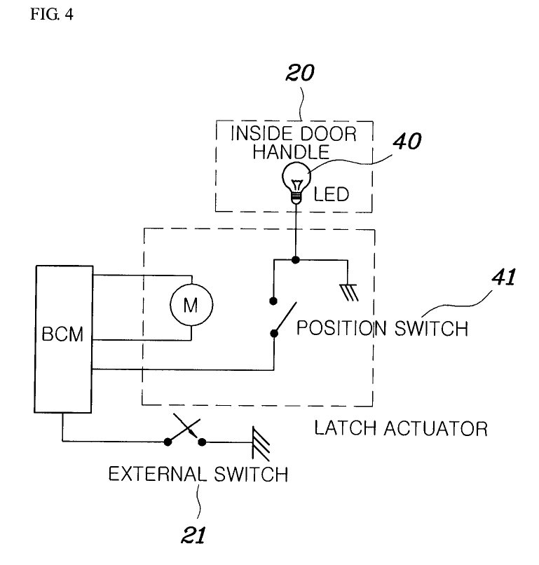

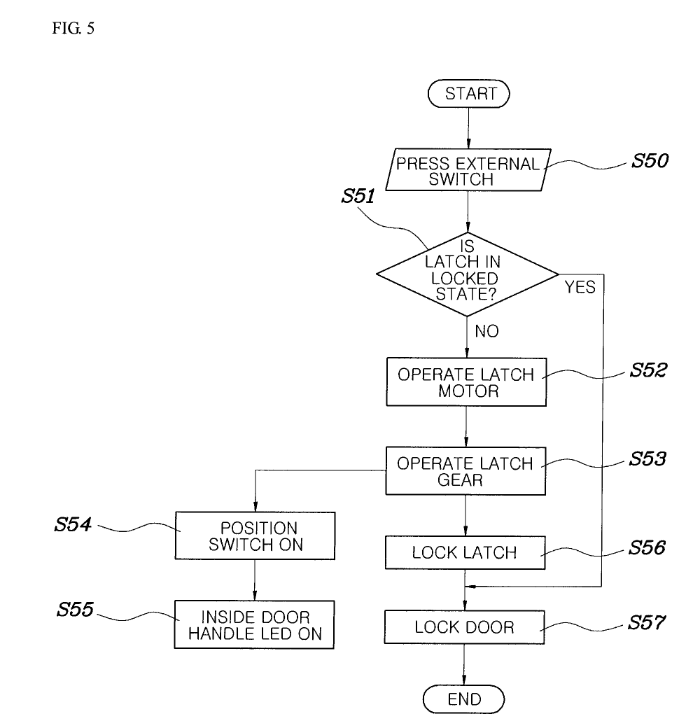

FIG. 2 is a view showing a system for controlling door locking devices which uses external switches according to various embodiments of the present invention. FIGS. 3A and 3B are views showing an inside door handle including an LED display unit for displaying whether a door locking device is locked or unlocked according to various embodiments of the present invention. FIG. 4 is a circuit diagram showing the LED display unit according to various embodiments of the present invention.

As shown in FIG. 2, one or more external switches with regard to the control of the door locking devices are provided in a vehicle according to various embodiments of the present invention. For example, a first external switch 21a may be mounted on the front seat vehicle occupant side of the vehicle and a second external switch 21b may be mounted on the rear seat vehicle occupant side of the vehicle. Here, the first external switch 21a may be mounted near a center fascia, and the second external switch 21b may be mounted near a center console.

In particular, the first external switch 21a and/or the second external switch 21b provide selection buttons or detailed operation buttons for controlling respective doors through a display implemented in the form of a touch screen near the center fascia or the center console, thereby increasing the convenience of use by the vehicle occupant.

Here, the first external switch 21a may be configured as a switch related to the control of door locking devices for front doors, and the second external switch 21b may be configured as a switch related to the control of door locking devices for rear doors. Of course, both the first external switch 21a and the second external switch 21b may be configured as switches related to the control of the door locking devices for all the doors mounted in the vehicle.

When the vehicle occupant operates one of the external switches, an electric signal is transmitted to one of the latch motors of the door locking devices, with the result that the latch motor is operated, so that a latch gear is operated, thus a corresponding door locking device can switch between the locked and unlocked states.

Further, each of the inside door handles 20a, 20b, 20c, and 20d, mounted in the vehicle according to various embodiments of the present invention, is configured to include an LED display unit 30 for displaying whether a door locking device mounted in the vehicle is in a locked or unlocked state, and a grip 31 for providing a function of unlocking the door locking device and opening a door, while a safety knob is not included as shown in FIGS. 3A and 3B. FIG. 3A represents the LED display unit 30 is unlighted when the door locking device is locked and FIG. 3B represents the LED display unit 30 is lighted when the door locking device is unlocked. It is sure that that setting can be switched.

According to various embodiments, the LED display unit 30 for displaying whether the door locking device is in the locked or unlocked state may include an LED 40 mounted inside an inside door handle, a position switch 41 configured to determine whether to supply/block power to the LED 40, the inside door handle 20 configured to transmit a control signal to the position switch 41, and an external switch 21, as shown in FIG. 4.

When a control signal, which provides notification that the door locking device is switching from a locked state to an unlocked state, is transmitted from the inside door handle 20 or from the external switch 21 to the position switch 41, the position switch 41 is opened, so that the supply of power to the LED 40 is blocked and the LED 40 is turned off. Meanwhile, when a control signal, which provides notification that the door locking device is switching from an unlocked state to a locked state, is transmitted, the position switch 41 is closed, so that power is supplied to the LED 40 and the LED 40 is turned on.

According to various embodiments, the state of the door locking device can be varied through the operation of the grip 31 of the inside door handle 20 and the on/off operation of the external switch 21. In particular, in the case of the operation of the grip 31 of the inside door handle 20, ‘one-motion override’ may be applied, or ‘multiple-motion override’, for example, ‘two-motion override’ may be applied.

Here, when a closed door is desired to be opened, the application of ‘one-motion override’ means that, if the grip 31 of the inside door handle is pulled once, the locked state of the door is released and, simultaneously, the door is opened. Further, the application of ‘multiple-motion override’ means that the locked state of the door is released and then the door is opened based on the frequency at which the grip 31 of the inside door handle is successively pulled.

The following Table 1 shows a door locking device state (in particular, a latch state), a position switch state, an LED state, and a door state based on the operation states of the inside door handle 20 and the external switch 21.

TABLE 1

| | | Number of | | Position | | |
|---|---|---|---|---|---|---|
| Method | Location | operations | Latch state | switch state | LED state | Door state |
| External | front, rear | no limit | locked | ON | turned on | closed |
| switch ON | | | | | | |
| External | | | unlocked | OFF | turned off | closed |
| switch OFF | | | | | | |
| Inside handle | front door | no limit | unlocked | OFF | turned off | opened |
| pulled | rear door | One | unlocked | OFF | turned off | closed |
| | | operation | | | | |
| | | Two | unlocked | OFF | turned off | opened |
| | | operations | | | | |

Table 1 shows the case in which motion override is differently applied depending on whether the inside door handle is mounted in one of the front doors or the inside door handle is mounted in one of the rear doors. In other words, in the case of the inside door handles mounted in the front door 20a, 20b, ‘one-motion override’ may be applied, and in the case of the inside door handle mounted in the rear door 20c, 20d, ‘two-motion override’ may be applied.

The reason for this is that there is a high probability that vehicle occupants, such as children or the old who may manipulate inside door handles by mistake, sit on rear seats, so that ‘one-motion override’ is not applied to the inside door handles mounted in the rear doors, thereby protecting the vehicle occupants in the rear seats.

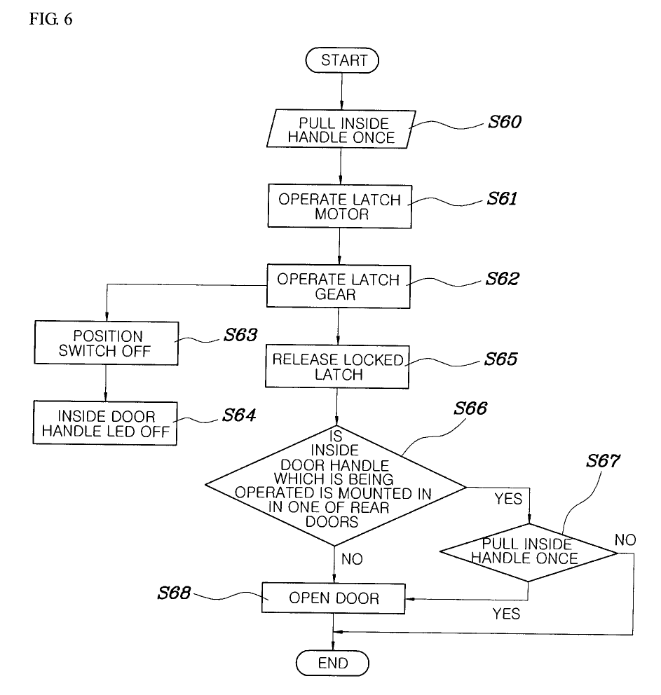

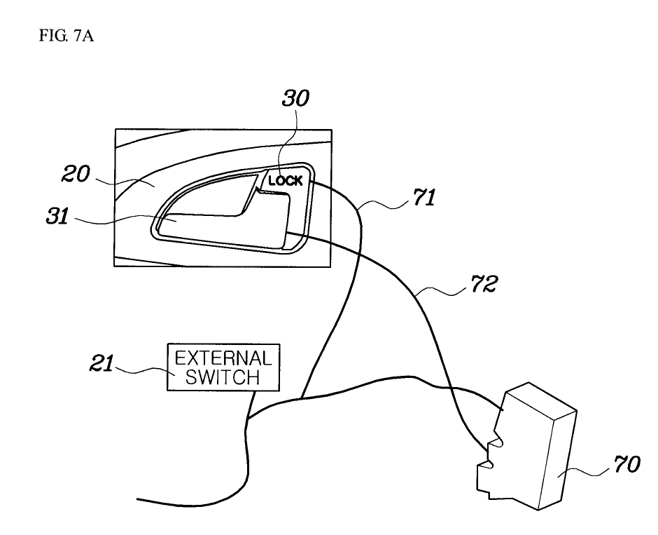

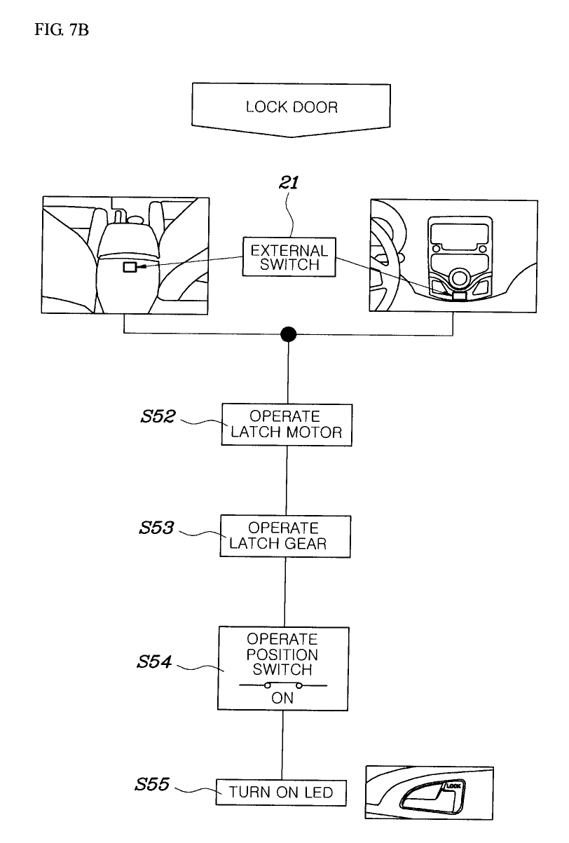

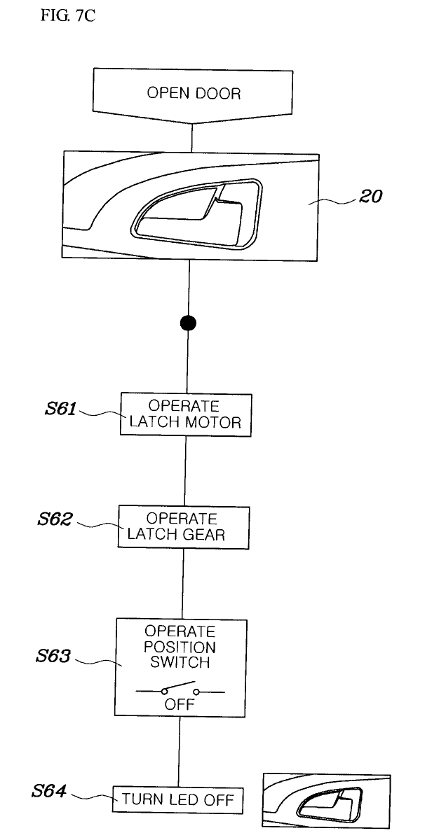

FIGS. 5 and 6 are flowcharts showing an example of a process of locking and unlocking a door according to various embodiments of the present invention. And, FIGS. 7A to 7C are also views showing the operation of the LED display unit together with respective configurations during the process of locking/unlocking a door according to various embodiments of the present invention.

First, an example of a process of locking a door according to various embodiments of the present invention will be described with reference to FIGS. 5 and 7B. The external switch 21 is pressed at step S50. When a electrical signal is transmitted to a door locking device 70, in particular, to the latch motor, connected to the external switch via a wiring 71, through the operation of pressing the external switch 21, it is determined whether the latch is in a locked state at step S51. If it is found that the latch is in the locked state, the process proceeds to step S57, and a corresponding door is locked and the process is terminated.

However, if, as the result of the determination whether the latch is in the locked state, it is found that the latch is not in the locked state at step S51, a latch motor is operated at step S52, a latch gear is operated at step S53, and the latch is in the locked state at step S56. Thereafter, the process proceeds to step S57, the corresponding door is locked and then the process is terminated.

Here, when the latch gear is operated at step S53, the process proceeds to step S54, the position switch is turned on, and the LED 30, mounted in the inside door handle, is turned on at step S55.

As described with reference to FIGS. 5 and 7B, the door locking device can switch to a locked state through the operation of the external switch, and, when the door locking device switches to the locked state, the LED mounted in the inside door handle is turned on, so that the state of the door locking device can be displayed.

An example of a process of opening a door according to various embodiments of the present invention will be described with reference to FIGS. 6 and 7C. The grip 31 of the inside door handle 20 is pulled once at step S60. When the grip 31 is pulled, a mechanical signal is transmitted to a door locking device 70, in particular, a latch motor, through, for example, a latch cable 72, so that the latch motor is operated at step S61, and the latch gear is operated at step S62.

Thereafter, the locked latch is unlocked at step S65. It is determined whether the currently operated inside door handle is mounted in one of the rear doors of a vehicle at step S66. If the currently operated inside door handle is not mounted in one of the rear doors, that is, the currently operated inside door handle is an inside door handle mounted in one of the front doors, the process proceeds to step S68, and the corresponding door is opened, and the process is terminated.

However, if, as the result of the determination whether the currently operated inside door handle is mounted in one of the rear doors of the vehicle, it is found that the currently operated inside door handle is mounted in one of the rear doors of the vehicle at step S66, the process proceeds to step S67. When the grip 31 of the inside door handle 20 is pulled once more, the process proceeds to step S68, and the corresponding door is opened and then the process is terminated.

Here, when the latch gear is operated at step S62, the process proceeds to step S63, the position switch is turned off, and then the LED 30 mounted in the inside door handle is turned off at step S64.

As described with reference to FIGS. 6 and 7C, the door locking device can switch to an unlocked state when the inside door handle is pulled. As the door locking device switches to the unlocked state, the LED 30 mounted in the inside door handle is turned off, so that the state of the door locking device can be displayed.

According to the system for controlling door locking devices disclosed in this specification, there is an advantage in that a vehicle occupant can manipulate door locking devices while safety knobs are not used.

Further, an advantage is expected in that cost may be reduced about 2000 won per vehicle by removing safety knobs and labels.

Furthermore, the states of the door locking devices are displayed using LEDs provided in respective inside door handles, so that there is an advantage in that a vehicle occupant can directly detect the states of the door locking devices even at night through using the LEDs.

For convenience in explanation and accurate definition in the appended claims, the terms “inside” and “external” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for controlling door locking devices, the system comprising:
inside door handles each configured to include a grip for unlocking the door locking devices, mounted in a vehicle and opening a door, and a display unit for displaying whether the door locking device is locked or unlocked; and
at least an external switch module mounted outside the inside door handles, each electrically-connected to the door locking devices, and each configured to enable a vehicle occupant to control the door locking devices.

2. The system as set forth in claim 1, wherein the grip is disposed in at least one of inside door handles mounted in respective front door of the vehicle and in case that the grip is pulled once, a corresponding door locking device is unlocked and a corresponding door is opened.

3. The system as set forth in claim 1, wherein the grip is disposed in at least one of inside door handles and in case that the grip is pulled twice, a corresponding door locking device is unlocked through first pulling of the grip and a corresponding door is opened through second pulling of the grip.

4. The system as set forth in claim 3, wherein the grip is included in one of inside door handles in the rear doors.

5. The system as set forth in claim 1, wherein the display unit displays whether the corresponding door locking device is locked or unlocked, based on operation of a position switch which operates in response to a signal transmitted through at least one of the inside door handles and the external switch modules.

6. The system as set forth in claim 1, wherein the display unit is a Light Emitted Diode (LED) display unit.

7. The system as set forth in claim 1, wherein each of the external switch modules is realized using a touch screen of a display mounted inside the vehicle.

8. The system as set forth in claim 7, wherein the external switch module enables the vehicle occupant to lock or unlock the locking devices for the respective doors through the touch screen.

9. The system as set forth in claim 1, wherein the external switch modules are mounted near or onto a center fascia.

10. The system as set forth in claim 1, wherein the external switch modules are mounted near or onto a center console of the vehicle.

11. A passenger vehicle comprising a system for controlling door locking devices of claim 1.
